(19) United States
(12) Patent Application Publication
(10) Pub. No.: US 2024/0411348 A1
(43) Pub. Date: Dec. 12, 2024

(54) MODULAR AIRFLOW THERMAL BARRIER FOR COMPUTERS IN A RACK

(71) Applicant: Daniel Morrison, Plano, TX (US)

(72) Inventor: Daniel Morrison, Plano, TX (US)

(21) Appl. No.: 18/741,124

(22) Filed: Jun. 12, 2024

Related U.S. Application Data
(60) Provisional application No. 63/472,453, filed on Jun. 12, 2023.

(51) Int. Cl. G06F 1/16

(52) U.S. Cl. CPC G06F 1/1656

(57) ABSTRACT

A modular thermal barrier for a computer is described. A modular thermal barrier panel is comprised of a non-conductive, heat-resistant material. The panel has an opening formed within the panel that is to be disposed around the case of a computer unit and positioned between a first side of the computer unit having an air intake and a second side of the computer having a hot air exhaust. Modular thermal barriers panels for two or more adjacent computer units within a rack or shelving system may be adjoined or overlapped to form a thermal barrier that inhibits the flow of air and transfer of heat between the adjacent computer units.

### RELATED APPLICATION

The present application is a non-provisional application claiming the benefit of priority under 35 U.S.C. § 119 (e) from U.S. Provisional Patent Application No. 63/472,453, filed Jun. 12, 2023, the entire contents of which are expressly incorporated herein by reference into this disclosure.

### FIELD

The present invention generally relates to an airflow thermal barrier for computers.

### SUMMARY

Embodiments of the invention comprise a modular airflow thermal barrier for computers. A modular thermal barrier panel is comprised of a non-conductive, heat-resistant material. The panel has an opening formed within the panel that is to be disposed around the case of a computer unit and positioned between a first side of the computer unit having an air intake and a second side of the computer having a hot air exhaust. Modular thermal barrier panels for two or more adjacent computer units in a rack or shelving system may be adjoined or overlapped to form a thermal barrier that inhibits the flow of air and transfer of heat between the adjacent computer units.

### BRIEF DESCRIPTION OF THE DRAWINGS

The accompanying drawings, described below, illustrate various components and interactions found in the embodiments of the present invention:

FIG. 1 is a front view of a modular thermal barrier panel having an opening for a computer unit according to an embodiment of the present invention.

FIG. 2 is a front view of a modular thermal barrier panel having openings for a plurality of computer units according to an embodiment of the present invention.

FIG. 3 is a perspective view of an example of a computer unit that may be used in connection with the modular thermal barrier panel of the present invention.

FIG. 4 is a perspective view of a modular thermal barrier panel of FIG. 1 disposed around a computer unit.

FIG. 5 is a perspective view of a modular thermal barrier panel of FIG. 2 disposed around a plurality of computer units.

FIG. 6 is a perspective view of a thermal barrier wall comprised of a plurality of modular thermal barrier panels from adjacent computers according to an embodiment of the present invention.

### DETAILED DESCRIPTION

Embodiments of the present invention are further described in detail below with reference to the accompanying drawings and embodiments. The following examples are intended to illustrate the invention, but are not intended to limit the scope of the invention.

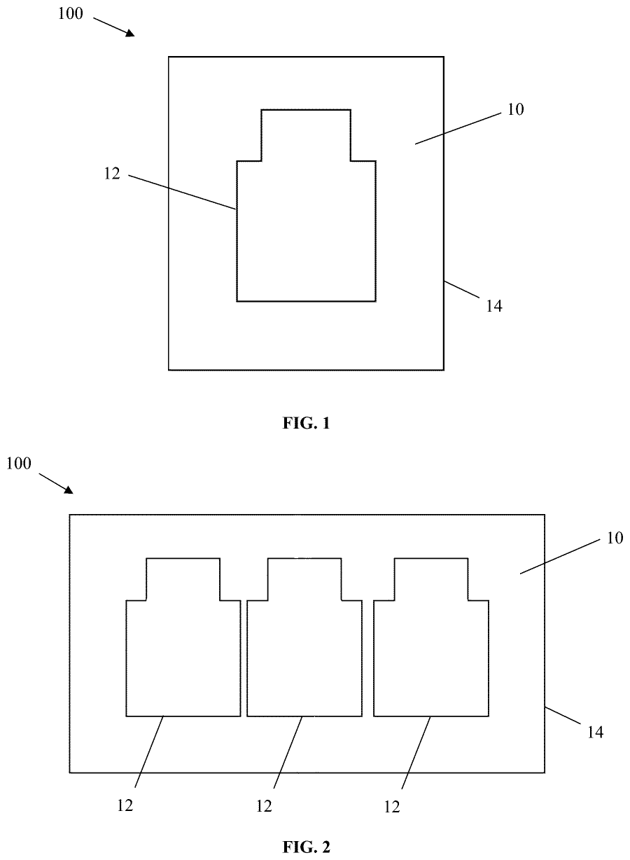

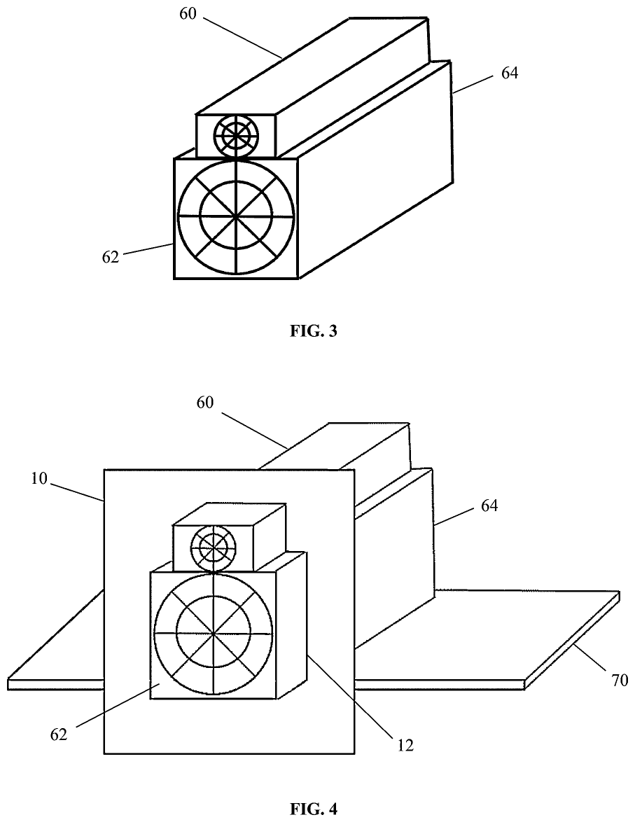

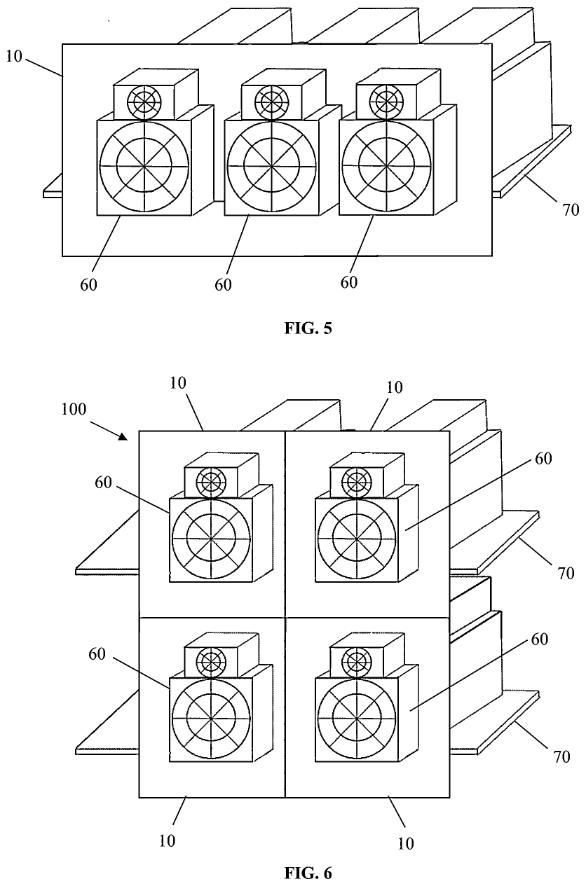

With reference to FIG. 1, embodiments of the present invention may comprise a modular airflow thermal barrier 100. The modular airflow thermal barrier is intended for use with computer units 60 such as shown in FIG. 3, in which the air intake is on a first side 62 of the computer unit and hot air is exhausted on the opposing second side 64 of the computer unit.

FIG. 2 depicts an example embodiment of a computer unit 60 that may be used in connection with the modular air flow thermal barrier panel of the present invention The computer unit 60 may be a personal computer, a computer server, a case comprising multiple computer units, or other data processing equipment. For example, the computer unit 60 may be a central processing unit (CPU), graphics processing unit (GPU), application-specific integrated circuit (ASIC), field-programmable gate array (FPGA), or the like.

As shown in the embodiment depicted in FIG. 1, a modular airflow thermal barrier 100 may comprise a thermal barrier panel 10. The thermal barrier panel 10 may be a sheet comprised of heat-resistant and non-conductive material that is preferably semi-rigid material for ease of handling and cutting. It is preferable that the material has a high heat tolerance. For example, the panel 10 may be comprised of thermally insulating material, such as extruded or expanded polystyrene foam insulation, fiberglass duct board, flexible graphite foil material. silica-based material, mica-based material, compressed cellulose material, compressed fiber reinforced material, polytetrafluoroethylene (PTFE)-based materials, foil insulation, or a composite comprising two or more layers of such materials.

The thermal barrier panel 10 may have an opening 12 formed within panel that fits around the case of a computer unit 60. The opening 12 may be cut to closely conform to the contour of the profile of the case of the computer unit 60 to minimize gaps between the barrier material and the computer unit through which air may flow. The opening 12 may also be formed to fit two or more different types of computer units 60, which may not provide a tight of a seal around the case of the computer unit 60 but will still provide an effective airflow thermal barrier. A portion of the computer unit 60 may slide through the opening 12 in the thermal barrier panel 10. Preferably, the thermal barrier panel 10 is placed at or near the first side 62 of the computer unit 60 where or at or near the second side 64 of the computer unit 60 from which air is exhausted. As depicted in FIG. 2, embodiments of the thermal barrier panel 10 may include a plurality of openings 12 formed within the panel for a corresponding plurality of computer units 60.

The thermal barrier panels 10 are modular and move with each corresponding computer unit 60. As shown in the embodiment depicted in FIG. 4, the adjacent modular panels 10 may be adjoined or overlapped with panels 10 placed on other computer units 60 which are horizontally and vertically adjacent in a rack or shelving system 70, such as may be found in a server room, data center, or crypto mining facility. By adjoining or overlapping the modular thermal barrier panels 10 on adjacent computer units 60, the panels 10 may form a modular wall which serves as thermal barrier 100 to inhibit the flow of air and transfer of heat for the computer units 60 on the rack or shelving system 70. The modular panels 10 can be formed into any desirable configuration of computer units 60 and can be easily added or removed to reconfigure the placement of or to add or remove computer units 60 from the rack or shelving system 70.

The modular thermal barrier panels 10 further accommodate imprecise placement of the computer unit 60 on a rack or shelving system. Because an airflow thermal barrier 100 is formed by adjoining or overlapping adjacent modular panels 10, precise placement of the computer units 60 on the rack or shelving system is not required for the barrier to effectively inhibit the flow of air and heat between the computer units. In contrast, for a conventional continuous barrier, the openings in the barrier are fixed and cannot be moved or adjusted to accommodate different arrangements.

The opening 12 in the modular thermal barrier panel 10 may be formed to fit to an individual computer unit or a model or type of computer unit 60, and the airflow thermal barrier 100 may therefore accommodate a variety of different models or types of computer units 60 on the same rack or shelving system 70. If a computer unit of one model or type is replaced with a computer unit of a different type, the modular panel 10 for the old computer unit can be replaced with a modular panel for the new computer unit and maintain an effective barrier. This is in contrast with a conventional continuous barrier, which would require all of the computer units on a rack to be of the same model or type or the openings in the continuous barrier would have to be modified to accommodate a change to a different type of computer unit.

The modular thermal barrier panel 10 can be constructed in any size to accommodate the vertical and horizontal spacing between computer units 60 on a rack system. The perimeter 14 of the modular panels 10 can be trimmed by the user using conventional cutting tools to further customize the application of the barrier in a specific location on a rack. The perimeter 14 of the modular panels 10 may further include an interlocking feature to enable connection between a plurality of the modular panels, for example, a tongue and groove, interlocking tabs. or the like, but which may still provide for easy reconfiguration of the panels. The modular panels 10 may also be connected by fasteners, connectors, framing, or the like.

The above description is only to preferred embodiments of the present invention and it should be noted that those skilled in the art can make improvements and modifications without departing from the technical principles of the present invention and as such, variations are also considered to be the scope of protection of the present invention.

What is claimed is:

1. A modular airflow thermal barrier comprising:
a plurality of panels comprised of non-conductive, heat-resistant material, each panel having an opening formed therein disposed around the case of a computer unit and being positioned between a first side of the computer unit having an air intake and a second side of the computer unit having a hot air exhaust;
wherein the plurality of panels are adjustably arranged to form a thermal barrier for a plurality of adjacent computer units.

2. The modular airflow thermal barrier of claim 1, wherein the plurality of panels are adjoined to form the modular thermal barrier.

3. The modular airflow thermal barrier of claim 1, wherein the plurality of panels are overlapped to form the modular thermal barrier.

4. The modular airflow thermal barrier of claim 1, wherein the plurality of panels include an interlocking feature around the perimeter of the panels to enable interlocking between the panels.

5. The modular airflow thermal barrier of claim 1, wherein the opening in each of the plurality of panels is formed to closely fit the contour of the profile of a case of a computer unit.

6. The modular airflow thermal barrier of claim 1, wherein the openings in the plurality panels in the thermal barrier are formed to fit two or more different types of computer units.

7. The modular airflow thermal barrier of claim 1, wherein the panels are disposed adjacent the first side of the computer units.

8. The modular airflow thermal barrier of claim 1, wherein the panels are disposed adjacent the second side of the computer units.
